(19) United States
(12) Patent Application Publication
(10) Pub. No.: US 2012/0078532 A1
(43) Pub. Date: Mar. 29, 2012

(54) NON-DISPERSIVE INFRARED SENSOR MEASUREMENT SYSTEM AND METHOD

(76) Inventors: David Edward Forsyth, Laguna Beach, CA (US); Wayne Kenneth Miller, Fort Jones, CA (US)

(21) Appl. No.: 12/889,656

(22) Filed: Sep. 24, 2010

(51) Int. Cl. G06F 19/00

(52) U.S. Cl. 702/24

(57) ABSTRACT

Non-dispersive infrared (NDIR) sensing systems employ a NDIR sensor coupled to a microprocessor to determine gas concentrations by employing slope-based methodologies that compensate for pressure variations, temperature variations, or both, which may compare NDIR signals with calibrated data. NDIR sensor systems may employ means for limiting the system peak current demand providing for the portability and scalability of the system. In NDIR sensor systems calculating gas concentrations using calibration data, the phase of the change in the NDIR output signal in response to a change in the infrared source emitter level may be measured as part of the calibration process.

### FIELD OF THE INVENTION

The present disclosure relates to means of electronic measurement of non-dispersive infrared (NDIR) sensing elements. More particularly, the present disclosure relates to the computational and calibration methodology used to interpret the measured data from the NDIR type sensor element.

### BACKGROUND

Various gases such as carbon dioxide and hydrocarbon based gases (methane, propane, acetylene, etc.) absorb narrow bands of energy in the infrared region of the optical spectrum. A NDIR sensor makes use of this property to measure the amount of the gas in question in the ambient atmosphere by emitting light from an infrared source and using a photosensor to measure the amount of energy absorbed by the gas in question.

In NDIR measurement technology, references and examples of measurement systems are generally based on signal amplitude measurements which are sensitive to voltage, temperature, and pressure changes. With respect to voltage issues in NDIR sensors, generally, the system which supplies the power to the NDIR measurement system is relied on to be robust enough to meet the current requirements of the NDIR emitter. This presents challenges particularly in battery operated systems due to difficulties supplying the high levels of peak current demands that are needed when the infrared emitter is enabled. These situations may result in difficulties in implementing NDIR based measurement systems incorporating smaller battery based power sources and achieving desirable levels of either sufficient power for stable measurements or sufficient battery life.

With respect to temperature issues in NDIR sensors, some types of NDIR sensors (particularly those with filament based lamps for infrared sources) require a reference sensor to be useful in environments with changing temperature and/or voltage. In addition, multi-variant calibration calculations are generally limited to the incorporation of information from a NDIR reference channel. Temperature data is usually incorporated separately, often as an adjustment to the gas concentration calculations. The curves for the temperature effects on the NDIR sensors are themselves complicated, and in fact, vary with PCO2 levels. Common correction methods apply a correction formula to the calculated PCO2 or to the raw signal output. In either case, the approach is problematic in that the correction varies with the gas concentration.

With respect to pressure issues in NDIR sensors, accurately compensating for changes in pressure is an issue particularly for filament based NDIR sensors as well as those that incorporate sealed optical gratings that may change under pressure. The effects of pressure are complicated in part due to the multiple sources of effects due to pressure changes such as changes in the gas absorbance curve and changing optical grate characteristics used to select the detected spectrum. That is, for some types of NDIR sensors, changes in pressure affect both the temperature and the gas concentration relationships. Generally, NDIR circuits fail to demonstrate the principle of the direct incorporation of pressure sensor information into the calibration and measurement process and generally, nor have the pressure sensors themselves been incorporated directly into common measurement circuits, in part because there is little commonality in the measurement circuit or component basis. In addition, there are difficulties in dealing with the changes in temperature, and power supply issues in these environments in addition to the hyperbaric issues which all add up to a product which is extremely difficult to implement well enough to be a commercial success in a hyperbaric environment.

Thus, there exists a need in the art for computational and calibration methodology used to interpret the measured data from the NDIR type sensor element that addresses issues related to voltage, temperature, and pressure changes.

### SUMMARY

The present disclosure, in one embodiment, relates to a NDIR sensor system for determining a gas concentration level that includes a NDIR sensor for detecting an emitted infrared signal in response to the presence of a gas; a circuit for receiving a signal from the NDIR sensor corresponding to the detected infrared signal, where the circuit generates a plurality of measurements based on the received signals that correspond to a rate of voltage change in the received NDIR signal due to a change in an output level of the NDIR infrared emitter; a memory for storing calibrated rate of voltage change data corresponding to a plurality of gas concentrations; and a microprocessor for comparing the rate of voltage change from the received of signals with the calibrated data and determining the gas concentration based on the comparison.

In another embodiment, a NDIR sensor system for determining a gas concentration level, the system includes a NDIR sensor for detecting an emitted infrared signal in response to the presence of a gas; and a microprocessor for receiving data from the NDIR sensor associated with the sensed infrared signal and for receiving data associated with an ambient pressure, where the microprocessor compensates for pressure effects on the NDIR sensor using the received ambient pressure data and calculates the gas concentration level based on the received data from the NDIR sensor associated with the sensed infrared signal.

In yet another embodiment, a NDIR sensor system for determining a gas concentration level includes a NDIR sensor for detecting an emitted infrared signal in response to the presence of a gas; a circuit for receiving and amplifying a signal from the NDIR sensor; a memory for storing calibrated data corresponding to a plurality of gas concentrations; a microprocessor for calculating the gas concentration based on the calibrated data and data received from the circuit; and a means of limiting the system peak current demand which operates to supply a current required for an NDIR infrared emitter and to reduce a current required from an NDIR power supply source.

In a further embodiment, a NDIR sensor system for determining a gas concentration level includes a NDIR sensor for detecting an emitted infrared signal in response to the presence of a gas; a memory for storing calibrated gas concentration data based on a calibration curve, where the calibration curve is generated by: sampling gases at a plurality of concentrations occurring at a plurality of ambient gas temperatures; measuring NDIR sensor signals of the sampled gas concentrations occurring at the plurality of ambient gas temperatures; determining a best fit calibration equation by approximating a calibration curve with a multi-variant fit based on the measured concentrations and associated temperatures; and computing a set of fitted coefficients corresponding to the calibration curve based on the measured concentrations and related temperatures; and a microprocessor for receiving data from the NDIR sensor associated with the sensed infrared signal and data from a temperature sensor associated with measured ambient gas temperatures and calculating the gas concentration by applying the received ambient gas temperature data and the received infrared signal data as variables to the calibrated gas concentration data received from the memory.

The present disclosure, in yet another embodiment, relates to a NDIR sensor system for determining a gas concentration level that includes a NDIR sensor for detecting an emitted infrared signal in response to the presence of a gas; a circuit for receiving a signal from the NDIR sensor corresponding to the detected infrared signal, where the circuit generates measurements based on the received signals corresponding to a phase shift in the received NDIR signal; a memory for storing calibrated phase shift change data corresponding to a plurality of gas concentrations; and a microprocessor for comparing the phase shift in the received NDIR signal with the calibrated phase shift change data and determining the gas concentration based on the comparison.

These and other features and advantages of the present disclosure will become apparent to those skilled in the art from the following detailed description, wherein it is shown and described in the illustrative embodiments, including best modes contemplated. As it will be realized, the embodiments are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a graph of NDIR slope versus gas concentration for a constant temperature and pressure;

FIG. 2 is a graph of direct NDIR output slope for a single measurement;

FIG. 3 is graph of NDIR signal rise time dependence on pressure and gas concentration;

FIGS. 4a, 4b, 4c, and 4d are circuit diagrams, according to certain embodiments;

FIG. 5 is a graph of an amplified NDIR signal showing slopes for two different gas concentrations with comparator based trigger levels for slope measurement;

FIG. 6 is a graph of pressure dependence related to differing gas concentrations;

FIG. 7 is a graph of the momentary IR source in-rush current when the IR source is turned on; and

FIG. 8 is a flow chart showing a pressure related PCO2 calculation process.

### DETAILED DESCRIPTION

The present disclosure relates to novel and advantageous NDIR sensor systems that determines gas concentrations using slope based methodologies, and further relates to NDIR sensor systems for determining gas concentrations that may be used in varying pressure environments, in portable applications, and in applications where ambient temperature changes otherwise are compensated for in the gas concentration calculation. The present disclosure further relates to employing a phase shift change comparison with calibrated phase shift change data to determine gas concentration.

NDIR sensor systems provided according to certain embodiments may be used in varying pressure environments or may be transported to different altitudes without requiring recalibration. That is, certain embodiments are usable in a number of markets that otherwise require recalibration or would not be practical for applications involving use in varying pressures. Generally, NDIR sensors can be affected by pressure, and for those sensors, certain embodiments provide means of compensating for pressure, which enables their use in such markets as diving rebreathers and hyperbaric chambers. In addition, for sensors that operate in environments at a different altitude than the full multi-gas concentration calibration, e.g., in approaches that calibrate to the atmosphere at one point but do not account for the fact that pressure can change the calibration curve, can result in inaccurate readings for higher concentrations if the full factory calibration curve was established at a different altitude. Accordingly, certain embodiments allow the use of NDIR sensors calibrated at one altitude but used at another, such as in an airplane or in a high altitude mine.

In other embodiments, NDIR sensor systems may be implemented to reduce the peak current requirements for the NDIR system power supply so that the IR emitter source is constrained and measurement consistency is improved to the degree that the system power supply is able to meet the demand with less voltage variance. Battery driven NDIR systems may thus be implemented using lower instantaneous current demands. By reducing the peak current requirements for the NDIR system power supply, embodiments overcome limitations associated with batteries, which otherwise provide large amounts of instantaneous current due to relatively high internal resistances. In addition, the signal response of the NDIR sensor is improved due to high sensitivities to variations in the infrared emitter output. Reducing peak current requirements in battery operated NDIR sensor systems improves battery life, uses in breathing system applications become available, and the NDIR sensor system may be usable for applications such as battery operated remote monitoring applications.

Additional embodiments provide for NDIR sensor systems having temperature sensitivity. Generally, temperature corrections are necessary in environments that either change temperature from the calibration temperature or have the possibility of changing temperature over time. However, temperature correction changes with gas concentration, which adds complexities to accurate temperature correction. For example, temperature correction may take place after a gas concentration has been calculated and/or multiple temperature correction formulas may be applied that are only based on an approximation of gas concentration. Certain embodiments described below provide NDIR sensor systems with temperature compensation features, and provides a means for a single, accurate calculation to be used to determine gas concentrations with a NDIR sensor rather than the use of multiple corrective equations.

NDIR Sensor Systems Using Slope Based Analysis for Determining Gas Concentration

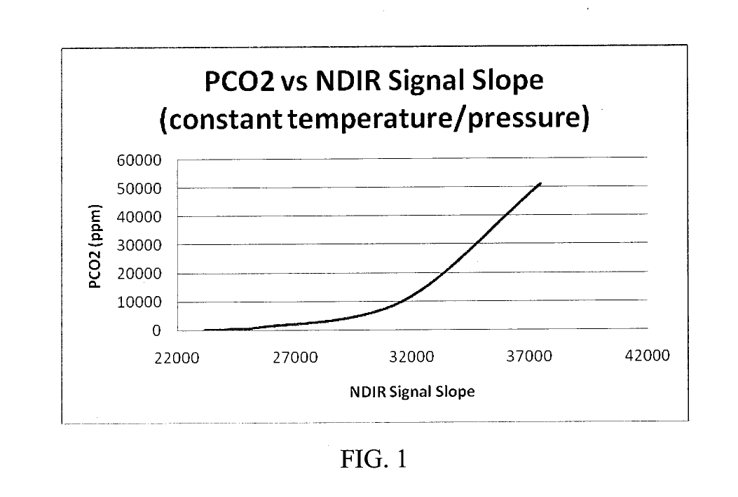

Embodiments disclosed herein provide improvements in NDIR sensor technology in several related areas. According to one embodiment, a NDIR sensor for detecting an emitted infrared signal in response to the presence of a gas is used with a measurement system which determines gas concentration based on a rate of NDIR signal change (slope) rather than the amplitude of the NDIR signal. FIG. 1 is a graph of NDIR slope versus gas concentration for a constant temperature and pressure. The graph shows the increase in time taken for a NDIR sensor signal to rise between two fixed voltage levels in one exampled set of measurements with units of time being approximately 5 us in this case. The graph represents the observable change due to change in gas concentration, for example, of a NDIR CO2 sensor in the rate of change (slope). It will be appreciated that for some types of NDIR sensors, the slope or rate of NDIR signal voltage rise time changes with gas concentration and may be used for that purpose.

The slope based measurement system provides a number of advantages over amplitude based approaches. Using a slope system for the NDIR signal measurement system provides a temperature response which is moderate, linear, not dependant on secondary or reference infrared sensing channels, and easy to calibrate against. Another advantage of the slope based measurement system is that the amplifier gain accommodates any individual NDIR sensor output without any additional adjustment in gain. In addition, another feature of this design is that a change in gain allows for an adjustment for either lower power or higher sensitivity and with either choice, will always be able to accommodate the full signal range of the NDIR sensor output. Another advantage of the slope based measurement system is that slope determination can be accomplished by timing the signal rise between two constant voltage levels requiring only a comparator and a timer which eliminates the more costly and power demanding approaches typically using an ADC circuit that are found in other approaches.

According to certain embodiments, a NDIR signal slope is obtained by measuring rise time of the voltage output of the NDIR active signal channel in the presence of the to-be-measured gas. The rise time changes according to gas concentration. High gas concentrations have a long rise time. Low gas concentrations have a shorter, steeper signal slope. In both cases, the full gain of the amplifier is employed due to the slope measurement approach, in which the microprocessor may wait the amount of time necessary for the signal to reach the fully amplified output level, time taken being the measured quantity in the represented embodiment. The time taken to complete a measurement may be changed by changing the amplifier gain. In a slope based system, the limits of resolution for low concentrations are due to a steep slope with a short measurement time (and thus limited resolution). The limits of measurements for high gas concentrations are a slow rise in the signal voltage which produces a flat slope with a long measurement time (possibly limited by either noise or power requirements). Other embodiments may use variable detected voltage levels with a fixed time base or both detection voltage and time for additional optimizations may be varied.

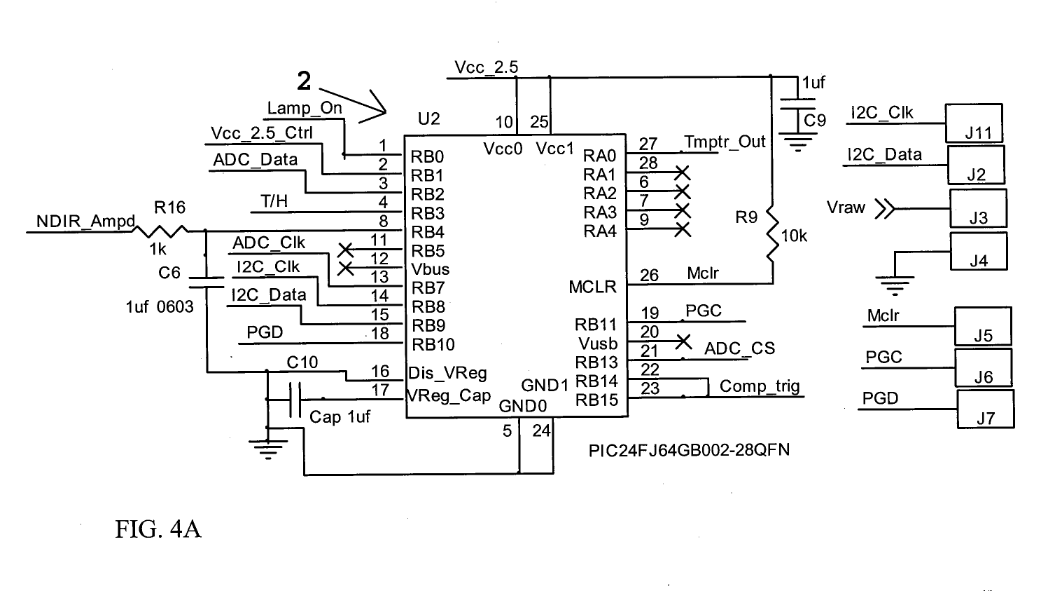

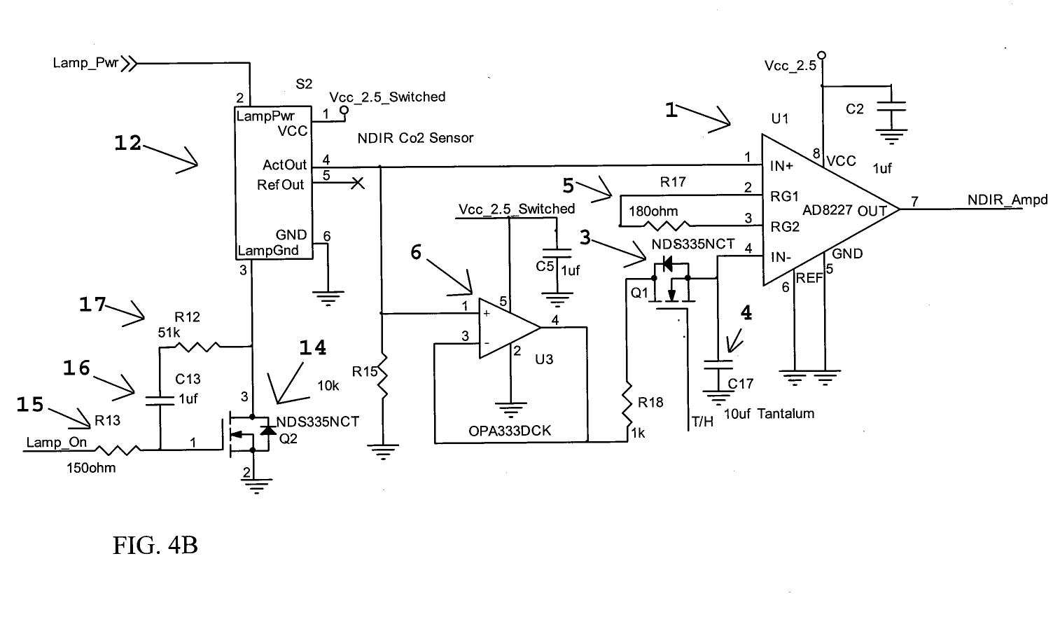

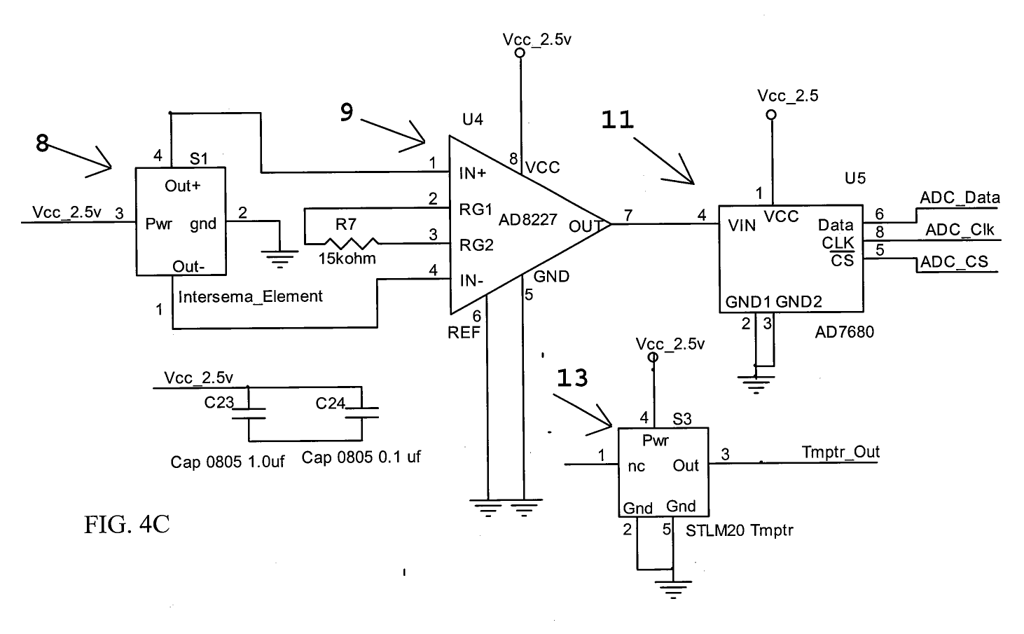

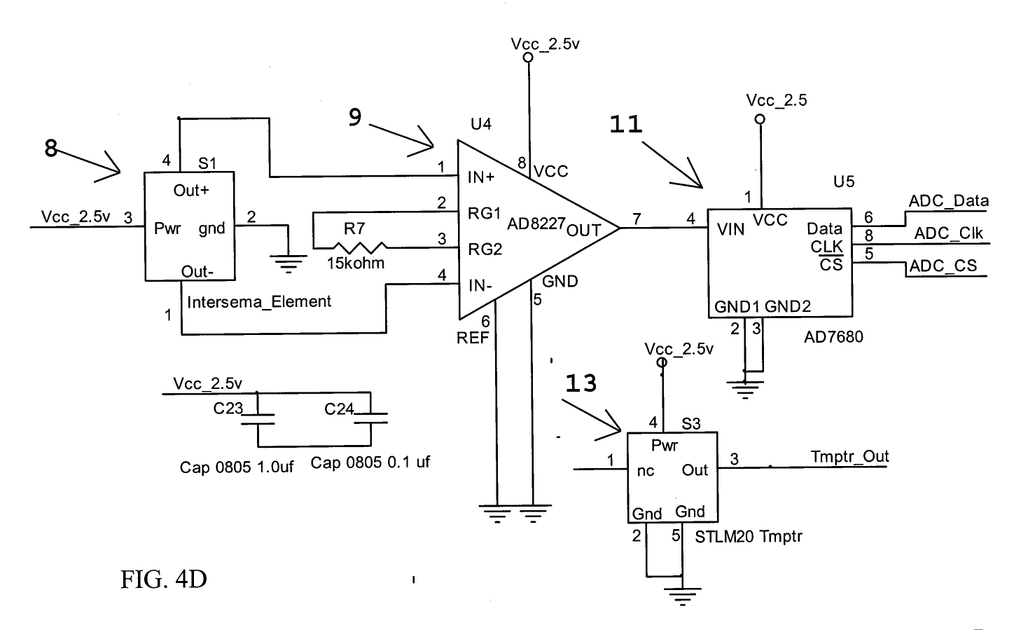

In another example system, although it is possible to use one gain setting and be able to produce acceptable measurements across the range specified for a NDIR sensor, it is also possible with the slope approach to easily implement system improvements by changing the gain, possibly under microprocessor control, to either decrease the power required for measuring high gas concentrations (by increasing the gain when high concentrations are detected, creating a shorter, steeper signal voltage slope), or to increase the resolution for low gas concentrations (by increasing the gain and creating a slower, longer slope) thus enabling similar measurement resolutions for different gas concentration levels. The practical possibility of this can be seen for example in the embodied circuit of FIG. 4b which shows a single gain setting resistor (connected between pins 2 and 3 of 1 (U1), the AD8227 instrumentation amplifier). Given that it is a single resistor in this embodied circuit, a variable gain to accomplish the above mentioned actions could be done with a multiplexed switch providing several different resistors and gains under microprocessor control. Sensors are specifically designed and optimized for a maximum range of concentration, but at the cost of losing resolution above that range and also losing resolution at the low end of the range as the sensor is tuned to increasing amounts of concentration at the high end.

Embodiments of NDIR sensor systems using the NDIR signal slope measurement may dynamically tune the sensor measurement electronics specifically to be more accurate at a specific target range of concentration, if desired, by adjusting the amplifier gain to optimize the consistency and slope of the measured signal.

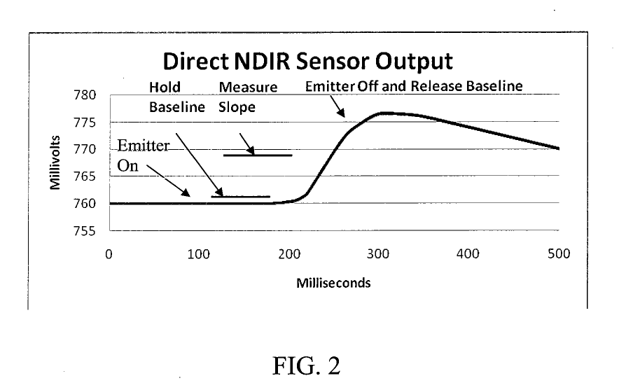

The rate of change for the signal produced by a NDIR sensor as a result of the detected gas concentrations is a function of the level of concentration. As an example, FIG. 2 shows a graph of the unamplified NDIR signal for a single measurement cycle. It can be seen that there is a response slope in the IR radiation sensed by the photodetector. This slope is consistent over the operational temperature range for the same gas concentrations and differs in angle for different sensed gas concentrations as shown by FIG. 2. FIG. 2 is a graph of direct NDIR output slope for a single measurement. As can be seen from the graph, FIG. 2 shows the NDIR infrared emitter being turned on and at a later point in time, a measurement baseline being established (discussed below) as one example of a rate of change measurement system. The slope is measured between two points as the signal rises (due to the infrared emitter having been turned on) at which point, the emitter may be turned off until the next measurement cycle.

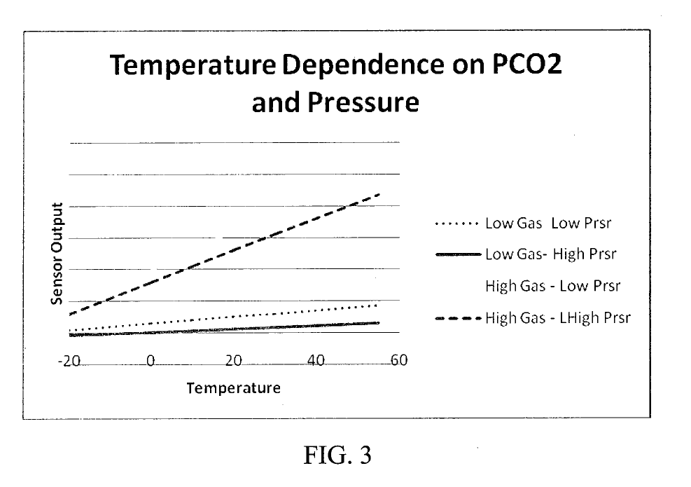

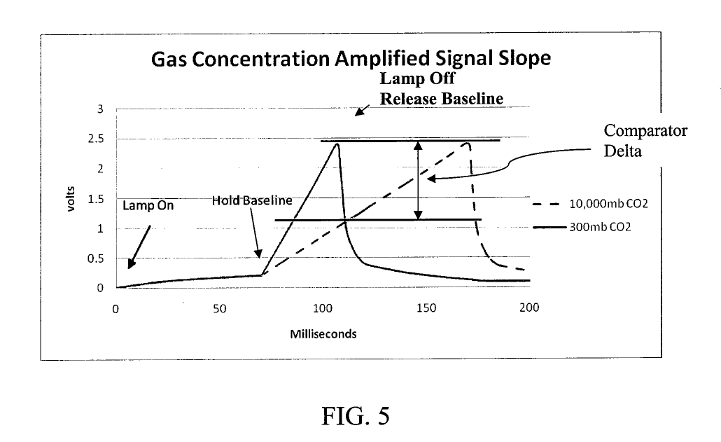

FIG. 3 is a graph of temperature dependence on pressure and gas concentration and shows the different slopes for two different gas concentrations. The FIG. 3 graph shows that the slope measurement will change in a predictable manner with temperature and that changing pressure will affect it as well (discussed below). The NDIR signal producing the information in FIG. 3 can be seen for two concentrations at a single temperature and pressure. FIG. 5 is a graph of an amplified NDIR signal showing slopes for two different gas concentrations with comparator based trigger levels for slope measurement. The trigger on/off points of a comparator based measurement system are shown relative to the slope amplitude as occurring in different amounts of time for the two concentrations. Note that if these were measurements made of the same concentration at either two different temperatures or two different pressures, that the results between measurements taken at the two conditions would look similar in some examples although the range of change would be different. In some embodiments, those differences would then be compensated for by the use of the changes in ambient conditions which effected the change.

The NDIR signal slope measurement method provides advantages over measuring absolute NDIR signal amplitudes. Specifically, absolute amplitude measurement methods are disadvantageous because the methods are sensitive to temperature and voltage fluctuations in ways that are difficult to easily or fully compensate for. Unlike the traditional measurement system, in the embodiments provided herein, the exact time of making a measurement after a change in the infrared source (emitter) is made is not critical. The slope is also fairly consistent over varying measurement cycle times. Improvement in the measurement results may be obtained with a secondary calibration using a low-frequency cycle time in addition to the main measurement cycle time. In addition, it is possible to use the calibrated cycle time to calibrate slower or faster NDIR measurement cycle times.

As can be seen from the raw signal in FIG. 2, a graph of direct NDIR output slope for a single measurement, once the initial warm-up time has passed, there is a period of time in which the slope measurement may be made with little specific regard to what exact position or length of time it is taken in, within the bounds of amplified signal stability and ultimately the signal reaching a true peak. Identified practical time ranges are on the order of 50 ms to several hundred milliseconds depending on amplifier gain. Although consistency always improves stability, the parameters of making the slope measurement are not critical.

According to certain embodiments, a measurement in time between sets of consistent voltage points (voltage domain) may be taken, or the measurements may be of the voltage difference that occurs between sets of consistent time separations (time domain). These measurements would occur in some amount of either time or sensed voltage after a change in the infrared source drive current, typically on or off, but may also occur for multiple levels of emitter source output. This delay between implementing a change in the NDIR emitter output and taking a slope measurement may be necessary to allow the NDIR sensor to reach a critical temperature sufficient for producing a stable rising output.

A slope based NDIR system may be implemented using a circuit for receiving a signal from the NDIR sensor corresponding to the detected infrared signal, wherein the circuit generates a plurality of measurements based on the received signals such that the measurements correspond to a rate of voltage change in the received NDIR signal resultant from a change in the output level of the NDIR infrared source emitter. This may be accomplished by using a comparator circuit to measure the time between two voltages. The circuit employs a microprocessor embedded window comparator with multiple arbitrary threshold voltages and a simple counter running during the comparative window. No ADC or accurately determined voltages or absolutely determined or known reference levels are required, but rather consistent voltage separations may be employed. This may be changed to allow different scales or multiple measurements to take place. The result is that the sensed and amplified NDIR signal shown in FIG. 4a/b (a circuit diagram according to certain embodiments) comes out of amplifier 1 (U1, AD8271) and feeds directly into the microprocessor 2 (U2, PIC24FJ64GB004). The microprocessor contains embedded voltage comparators and uncalibrated voltage reference, and generic timers which are then utilized for making the slope measurements. Use of the measured information is discussed below.

Changes in concentration levels results in a measurable change in the NDIR sensor response slope. FIG. 5 is a graph of an amplified NDIR signal showing slopes for two different gas concentrations with comparator based trigger levels for slope measurement. In this example, it is shown in FIG. 5 that an amplification of the NDIR signal may produce different rise times as a result of changing gas concentrations. The signal output may be measured as it occurs some time after a rapid change in the IR source level. This provides the ability to control resolution and sensitivity in a slope based system by changing the gain or measurement time base (timer frequency), in order to get more information out of a steep slope (low gas concentration—use lower amplification and/or higher clock frequency) or decrease noise and power out of a long slope (high gas concentration—use higher amplification and/or slower clock).

Another principle involved in slope based measurement systems is that gain needs to be consistent, but the specific gain amount is no longer critical to obtaining a full measurement. The slope information is obtained in the time that it takes the amplified signal to rise from a low to high voltage within the full scale of the amplified signal range. While calibration or adjustment to calibration would have to be made for gain changes, and there are bounds of time-counter speed and resolution, it makes little practical difference to the slope measurement if the gain is twice or half as much as some optimal middle value. The same signal will be present, but it just takes more or less time with little effect on the usefulness of the measurement unlike other systems which must decrease the gain to accommodate the maximum anticipated signal at the expensive of low signal resolution.

In FIG. 4a, the circuit 2, (U2, the PIC24 processor) configured such that pin 8, IO channel RB4 is configured to operate as the D input for comparator two. Comparator two is initially setup to compare the D input against a low voltage (approximately 0.7V out of 3V) internally generated from the microprocessor supply voltage via a resistor divider. Once the infrared lamp is turned on and the NDIR active sensor signal passes the low voltage reference point, the comparator input voltage from the voltage reference is reconfigured for a relatively high voltage (closest to the 3V power source) and one of the internal timers is started. The timer is configured such that pin 23 of the PIC24 acts as a gate which controls the timer. Pin 22 of the PIC24 is configured to be an output of the comparator such that when the comparator detects that the amplified NDIR signal becomes greater than the low reference voltage, the gate is driven high and starts the timer. When the voltage reference is reconfigured to a high voltage, the polarity of the comparator output is changed such that the timer will stop once the amplified NDIR signal becomes less than the high reference voltage. The timer value is then used as the equivalent of the slope of the signal for all calibration and measurement purposes.

Full temperature compensation is possible over the entire range of practical NDIR use with only one active NDIR sensor channel rather than the standard use of two sensor channels (active and reference) used to provide an active to reference ratio. Temperature compensation provided according to the present embodiments provides advantages because temperature variation with a slope based measurement system is linear for any specific gas concentration without the use of a NDIR reference signal. That is, the slope based measurement is linear in temperature response. This also allows for a less complicated and less expensive NDIR sensor with no need for a NDIR reference sensor and also allows for fewer calibration points and lower order calibration calculations. FIG. 3 is graph of NDIR signal rise time dependence on pressure and gas concentration showing both the change in temperature dependence for differing gas concentrations but also the change in temperature dependence with pressure.

According to certain embodiments, the memory for storing calibrated rate of voltage change data corresponding to a plurality of gas concentrations is contained within the microprocessor (FIG. 4a, 1, U2, PIC24FJ64GB004). The microprocessor contains instructions which compare the rate of voltage change from the plurality of measured NDIR signals (slope measurements) with the calibrated data and determining the gas concentration based on the comparison.

Baseline Amplifier for Slope Based Analysis of the NDIR Sensor Output for Determining Gas Concentration

The use of a baseline approach allows an optimized choice to be made in terms of what part of the NDIR sensors signal behavior relative to the IR source change is amplified. According to one embodiment, baseline amplifier is employed as opposed to amplifying the whole signal behavior. For example, a track and hold track and hold configured differential amplifier may be used in an NDIR sensor system for purposes of amplifying the emitted signal. A track and hold configured amplifier may include components such as a capacitor, a switch that is charged with and that retains the baseline voltage, and an amplifier that amplifies the difference between the baseline voltage and the sensed voltage corresponding to the infrared signal sensed by the NDIR sensor. That is, using a baseline amplifier, only the part of the signal with the most relevant information is amplified. This allows for a higher level of signal amplification and may be switched in polarity to allow the full voltage range to be used for the increasing and decreasing signal occurring after an increase or decrease of the infrared emitted energy. Accordingly, certain embodiments provide advantages over other approaches in which the signal is AC coupled and must be biased to the middle of the amplified voltage range where each positive and negative swing are only able to be amplified to half of the full amplifier range which results in a lower resolution.

Providing a baseline circuit in NDIR applications, according to certain embodiments, replaces the capacitive coupled, frequency tuned amplifier circuits used in other NDIR applications. The baseline oriented circuit has a number of advantages over typical NDIR amplifiers particularly in conjunction with the use of a slope based analysis of the NDIR sensor output. When used in a slope based measurement system, the baseline approach allows a starting point to be chosen such that the baseline point itself becomes one measurement point of a slope determination. This means that the mechanics, programming, and circuitry necessary for a slope determination may be decreased. As one example, a simple timer started at the time of baseline capture that runs until a voltage comparator is triggered by the differentially amplified signal voltage crossing a reference voltage will yield a slope related number that is directly related to the gas concentration. This eliminates an analog to digital converter circuit element and only relies on non-critical components—much of which can be found in standard microprocessors. The baseline can be dynamically adjusted as required to maintain an optimum position relative to the signal voltage behavior which may change depending on differing needs for speed, power reduction, accuracy, or resolution.

The fundamental principle of interest in amplifying a NDIR output signal is to separate and amplify a small signal (typically on the order of millivolts) sitting on top of a large DC bias of typically several volts. The baseline circuit fundamentally employs the means of holding a NDIR output signal level that occurs after a change in the IR source emission levels. The subsequent amplification will be made in relation to that held signal level such that the difference between the ongoing NDIR signal and the held, reference or baseline level is what is amplified. The determination of sensed gas concentration levels does not depend on any absolute detection level so it does not matter the specific level at which the baseline has been set.

The baseline may be established by a number of means including a simple FET switch connected to a voltage holding capacitor or a direct capture measurement via an analog to digital converter.

In addition, the baseline circuit is, with minor modifications such as an input multiplexer, able to be used to measure other sensor signals that may or may not be dealing with DC biases. Thus, certain embodiments allow for the inclusion of additional sensor signals using a common measurement circuit basis, both because of the nature of the circuit and also because it is not inherently frequency based and so can be switched between differing signal inputs and used regardless of whether the measured signal has a large offset or no offset. As a result, the NDIR sensor may be run on an intermittent basis more effectively compared to an AC coupled circuit.

FIG. 4b shows a baseline amplifier constructed out of a common NFET (3, Q1: N-type ND3332) and voltage-holding capacitor (4, C17:10 uf) connected to a high gain single stage amplifier 1 (U1 ADC8720) with a gain of approximately 400 as set by the gain resistor 5 (R17=180 ohms). There is a general purpose low-offset opamp 6 (U3, OPA2333) on the input of the baseline FET 3 to buffer the charging current requirements of the hold capacitor from the actual measured signal. This provides an improved baseline voltage on the holding capacitor 4. The holding capacitor 4 itself is sufficiently large and has low enough leakage as to hold the required baseline voltage for the relatively long periods of time (up to several hundred microseconds) as it may take high gas concentrations to achieve full range amplification.

According to certain embodiments, an input multiplexer may be used to select the output of a series of NDIR or other sensors with no additional measurement circuitry except either separate in-rush control circuits or a multiplexer on the output of that circuit and perhaps a larger supercap 7, C12 (likely 1 to 3 F).

Pressure Sensor

According to certain embodiments, an NDIR sensor for detecting an emitted infrared signal in response to the presence of a gas is used with a measurement system which determines gas concentration based on a rate of NDIR signal change (slope) wherein the circuit further comprises circuitry for measuring a pressure of the gas. This embodiment is provided in FIG. 4c, which depicts an Intersema pressure sensor 8 (S1, MS5412) which is operably connected to an instrumentation amplifier 9 (U4, AD8227) with a gain of approximately 10. The amplified signal is then measured by analog to digital converter 11 (U5, AD87680). The converter provides signals to the microprocessor using a SPI communications bus thereby allowing the microprocessor to access and relate the pressure information as necessary for either pressure compensation for the measured NDIR signal and be available for communication to the system connected to the NDIR sensor circuitry.

Pressure Compensation in the NDIR Sensor System for Determining Gas Concentration

Embodiments disclosed herein provide improvements in NDIR sensor technology related to the use of ambient gas pressure sensors.

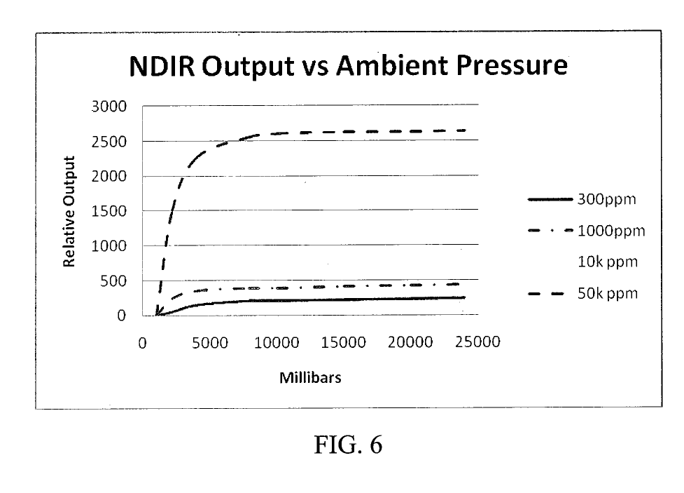

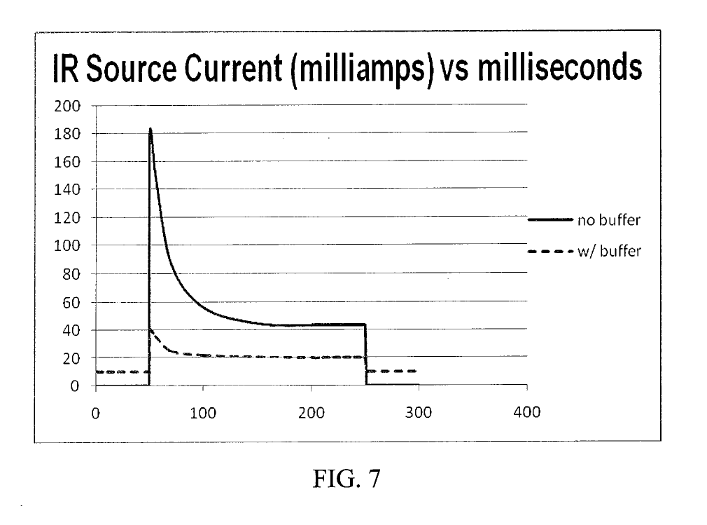

NDIR sensors vary in pressure sensitivity according to the type of construction, with those that use optical gratings tending to be more pressure sensitive than others. In any case, the ability to compensate for the effects of changes in pressure has been generally unsuccessful due to the complexity of the effects. Changing ambient pressure may be a difficult parameter for a NDIR sensor to accommodate as there are a number of sources of pressure related effects: changes in the absorbed frequency, spread (Q) of that absorbed infrared frequency, changing the optical properties of the IR Source and/or the IR sensing system. The net pressure effect will be different depending on the means of construction of the NDIR sensor. For example, FIG. 6 is a graph of pressure dependence related to differing gas concentrations which shows the differences in sensor output signals for different gas concentrations at a number of different pressures for a NDIR with a filament based infrared emitter and an optical grating applied to the infrared sensor. It is shown that the effect of pressure changes will differ with gas concentration for the exampled NDIR sensor and it would be inadequate to have one standardized pressure compensation that is meaningful across a range of gas concentrations and a range of pressures.

A NDIR sensor is used for detecting an emitted infrared signal in response to the presence of a gas. The NDIR signal will vary with detected gas concentration. The signal is measured by a microprocessor which also receives current (e.g., ambient) gas pressure information. The microprocessor also uses the results of a calibration process which is stored in a memory accessible to the microprocessor. The calibration process stores the relationships of measured NDIR sensor outputs and pressure sensor inputs at a plurality of gas concentrations and gas pressures. These relationships of gas concentration, NDIR signals, and gas pressures are stored in the memory used by the microprocessor. The microprocessor then compares current NDIR sensor outputs and current ambient pressure information to the calibrated values in order to determine the current gas concentration.

Pressure Compensation Using Multi-Variant Pressure Calibration and Calculation for Determining Gas Concentration

As shown in FIG. 4a/b, a NDIR sensor 12 (S2) is connected through an amplifier 1 (U1, AD8227) to a microprocessor 2 (U2, PIC24FJ64GB002). Pressure information is also received by the microprocessor in one embodiment through a SPI bus interface as measured by an analog to digital converter (FIG. 4c, 1 U5, AD7680). Pressure compensation uses more than one set of calibration gas concentrations, each calibration set occurring at a different ambient pressure for a range of gas concentrations. The number of calibration pressures used depends on, for example, the range of pressures to be accommodated, the construction and type of NDIR sensor, and the gas concentration accuracy desired. In some environments and NDIR sensor types, a change in pressure initially produces a pressure transient in some types of NDIR constructions that may be addressed by standard time based averaging and slew-rate limiting techniques.

To illustrate, a pressure change from 1000 mb to 16,000 mb was calibrated using pressures at 1000 mb, 2000 mb, 4000 mb, 6000 mb, and 16,000 mb. As can be seen from FIG. 6 which is a graph of pressure dependence related to differing gas concentrations for one NDIR sensor, the greatest change occurred at less than 6000 mb. Specific pressures to calibrate other systems to will depend on the specific behavior of the type of NDIR sensor used.

Challenges with NDIR sensing technology are that temperature induced offsets and pressure induced offsets change with gas concentration. The most common correction methods apply a correction formula to the calculated PCO2. Other correction methods apply the correction to the raw signal output. In either case, problems arise because correction varies with the gas concentration, and the result is that either the sought after gas concentration value is approximated, e.g., using a partially calculated result in order to get an approximate correction factor or additional calculations are required in an iterative approach, or multiple formulas are used depending on different approximate gas concentration ranges.

According to certain embodiments, a multivariable curve is fit to the data generated during the calibration process that uses both pressure and the NDIR sensor output. In this way, the calibration process can be used to determine the constants in a single equation that incorporates the parameters of interest and no approximation is necessary. One approach is to use a multi-order 2 variable polynomial and use a standard curve fitting technology such as a least-squares methodology to calculate the constants of the equation to fit the data as measured at a plurality of gas concentrations and pressures during the calibration process. These constants are stored in the microprocessor memory and accessed during the calculation process by taking present gas signal measurements and concurrent pressure data which are then incorporated into the polynomial equation with the calibrated equation constants as obtained from the microprocessor memory with the result being the present level of gas concentration.

Additionally, it is noted that for non-hyperbaric applications, a change in altitude will affect normal NDIR sensors, particularly filament/optical grating based devices. For this reason pressure measurement and calibration between the atmospheric pressure at the maximum operational altitude and sea-level pressure should also be considered for applications involving the possibility of difference in use altitude from the altitude at which the device was calibrated.

Pressure and Temperature Compensation Using Multi-Variant Pressure Calibration and Calculation for Determining Gas Concentration

In a further embodiment, an additional dimension is added to the calibration calculation in that a polynomial that has been curve fitted to the NDIR signal and pressure information is extended to an additional variable for the inclusion of temperature data. One embodiment of FIG. 4a, b, c shows a temperature sensor 13 (FIG. 4c, S3, STLM20, pin 3) as measured by an analog input to microprocessor 2 (FIG. 4a, U2, PIC24FJ64GB004, pin 27, RA0). Since the temperature effect is linear with concentration, it may be effective to use a relatively low ordered fit. In an example, an additional second order polynomial fit is used with regards to temperature and an approach will use standard multi-variant least squares fit analysis to obtain the relevant variables as they apply to temperature, pressure, and the NDIR signals as collected in the calibration process. These constants are stored in the microprocessor memory and are accessed during the calculation process by taking present gas signal measurements and concurrent pressure data which are then incorporated into the polynomial equation with the calibrated equation constants as obtained from the microprocessor memory with the result being the present level of gas concentration.

NDIR Pressure Calibration and Calculation Using Interpolation for Determining Gas Concentration

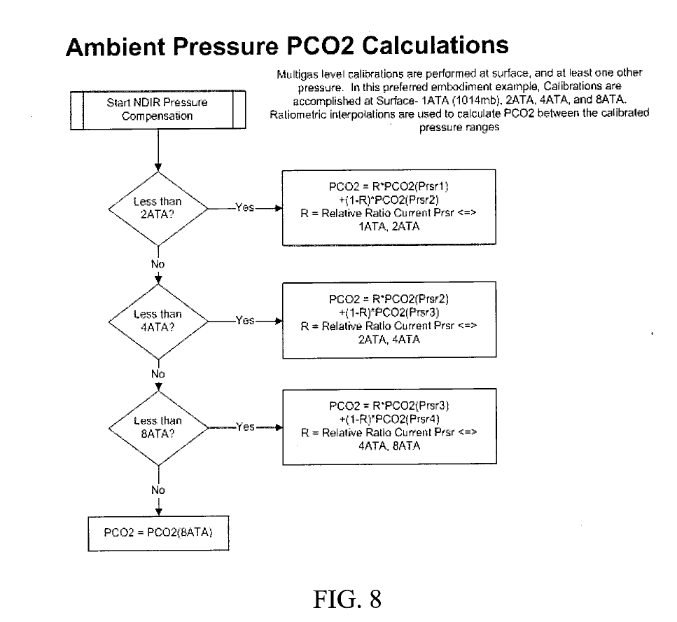

According to a further embodiment, a NDIR sensor system may further comprise a memory storing calibrated gas concentration data coupled to the microprocessor in which the calibrated gas concentration data may be based on a multiple constant pressure calibration curves using a interpolative process to determine gas concentrations at intermediate pressures. As shown above, calibration data may be collected by measuring a plurality of gas concentrations at a plurality of pressures. One method of determining a constant pressure calibration is to apply standard curve fitting techniques to a formula, such as a polynomial equation, using least-squares techniques to determine the best value of the related constants for each pressure curve. These variables are stored in a memory accessible to the microprocessor. In addition, the data may be examined to determine an approximate formula which represents the shift in concentration with pressure so as to determine a weighted formula to apply to the interpolation process. As it is desired to determine gas concentrations, the microprocessor uses the NDIR signal level and the concurrent pressure information and compares it to the stored calibration information, using the information for the constant pressure curves closest to the received pressure information and in one example, using a ratio or weighted ratio of the compared pressures to the received pressure to determine a interpolated gas concentration value from the constant pressure curve information stored in the memory calibration information. FIG. 8 shows one example of a flow chart using an interpolated gas concentration approach.

Peak Current Reduction in NDIR Sensor System for Determining Gas Concentration

As an example, a NDIR sensor, when measured, was found require the momentary inrush currents of as much as 150 ma. It is possible to use less but measurement signals are then affected. If the power supply system is not capable of meeting this level of peak demand, it may have irregular effects on the NDIR signal output since the amount of the limit is likely to change in that it is not a specifically controlled limitation. On the other hand, a power supply system that is designed to reliably produce the peak demand current is often up to 10 times more powerful than is actually needed for the overall NDIR power requirement if that peak power were able to be spread over a larger amount of time such as is possible with the use of a current buffer and inrush current control. FIG. 6, a graph of the momentary IR source in-rush current when the IR source is turned on. As can be seen in this graph, with no buffer, the current demand is substantially greater than when a current buffer is employed. In addition, if the buffer is sufficiently large, it is possible to use a supply which has little peak supply capacity beyond a required steady state demand. If the power supply is unable to supply the required current, the result will be changes in the supply voltage that may adversely affect the NDIR output signal. As a result, battery powered systems are affected in several different ways. The choice of battery chemistry and battery size is made more demanding as the chemistry must be selected with a low enough internal resistance to supply the specified amount of inrush current without an unacceptable effect on battery supply voltage. In addition, the battery must have a big enough capacity to meet the battery life rating of the system such that at the end of its rated use time, the battery is still capable of meeting the inrush current requirements. This can place a greater demand on the necessary battery capacity than if the power required to turn on the NDIR infrared emitter is either spread out over the measurement cycle and/or is limited to a specific maximum amount.

One embodiment of a NDIR system that addresses these issues includes a NDIR sensor using calibration data collected and stored as described above with a microprocessor receiving current NDIR signals and comparing those signals against the stored calibration data in memory also as described above. In addition, circuitry sufficient to reduce the peak demand current placed on the system power source may also be provided. For example, circuits may control the instantaneous current demand of the NDIR infrared emitter when turned on, or circuits may provide a local source of energy sufficient to buffer or spread out the instantaneous peak demand over a sufficiently large period of time such that the NDIR system power source has a sufficiently low enough demand at any one point in time such that NDIR system current and voltage requirements are met within the parameters that the system power supply and connections are capable of delivering.

One means of reducing the peak current of an NDIR sensor system comprises an inrush current control circuit coupled to the NDIR power source circuit controlling an infrared emitter of the NDIR sensor. An example of this is shown in FIG. 4b (a circuit diagram according to certain embodiments). The IR source is operably connected to a circuit principally comprised of a NFET 14 (Q2, NDS3335) and the 15 (R13, 150 ohm), 16 (R12, 51 kohm), 17 (C13, 1 uf) RC combination which controls in-rush current. The in-rush current supplied to the NDIR emitter is constrained to a voltage ramp that takes approximately 30 ms to reach the maximum voltage supply and limits the total inrush to about a 60 ma peak. The IR source is turned on when the gate to 14 (Q2) is driven high by the microprocessor.

A current buffer allows the power required for the NDIR sensor to be delivered over a longer time span than the instantaneous demand. The instantaneous system supply requirements are greatly reduced which allows a battery to be more fully consumed. The practicality of battery driven NDIR systems is improved with lower instantaneous current demands since many battery technologies are limited in providing large amounts of instantaneous current.

According to certain embodiments, a current buffer includes a capacitor 7 of at least 0.1 Farads coupled to a NDIR power source circuit powering an infrared emitter of the NDIR sensor. In the embodiment depicted in FIG. 4a/b/c/d, the NDIR measurement system includes a current buffer 7 attached to the output of the 3V regulator 18 (U6, LP5951-3.0) in the form of a 1F supercap 7 (FIG. 4d, C15) to distribute the current demand. This allows current supply to be remain functional below 10 ma rather than requiring the ability to deliver 80 ma to 140 ma on instantaneous demand as was the case with this circuit without peak current reduction. In an additional embodiment, in FIG. 4d, a switching power supply 19 is used to increase the supplied voltage to 4 volts and the NDIR sensor is run off of 3 volts. This provides a voltage buffer that allows for dips in the supply voltage by providing an amount of headroom before the 3V supply to the IR Source is affected. Either voltage supply may employ the current buffer. The combination of these circuits makes it possible to operate consistently in low power and/or long-weak cabled (remote) situations without affecting the operation of the IR source.

According to another embodiment, a NDIR sensor system means of reducing the system peak current demand includes a current buffer with of a rechargeable battery coupled to a NDIR power source of the infrared emitter. The rechargeable battery serves as a system current buffer and operates similarly to the functionality described above for a current buffer.

Another embodiment provides a NDIR sensor system with means of reducing the system peak current demand using both a current buffer and a peak in-rush current limiter. In this embodiment, as shown in FIG. 4a/b/d, both the peak in-rush limit circuit (NFET 14 (Q2, NDS3335) and the 15 (R13, 150 ohm), 16 (R12, 51 kohm), 17 (C13, 1 uf)) and the current buffer 7 (C15) are employed to the additional advantage in that total power required is reduced due to the peak in-rush limiter and the instantaneous demand for power is also greatly reduced by the current buffer to a net advantage in terms of the power supply requirements for operating the NDIR system.

In certain alternative embodiments, the system current buffer may be provided as a rechargeable battery coupled to a power source of the infrared emitter.

Additionally, an embodiment is represented in FIG. 4a/b/c/d, which shows the NDIR sensor system as discussed above in which FIG. 4c shows a pressure sensor 8 (S1) and the associated measurement circuitry to facilitate ambient pressure measurements to the NDIR system microprocessor 2. This is a useful extension of the peak current reduction circuitry in that many hyperbaric applications are possible with sufficiently low power requirements such that small batteries become practical power sources.

Multi-Variant Temperature Compensation Method for Determining Gas Concentration

In another embodiment, a multivariable curve is fit to the data generated during the calibration process that uses both temperature and the NDIR sensor output is provided in the NDIR sensor systems. In this way, the calibration process can be used to determine the constants in a single equation that incorporates the parameters of interest and no approximation is necessary. One approach uses a multi-order 2 variable polynomial and uses a standard curve fitting technology such as a least-squares methodology to calculate the constants of the equation to fit the data as measured at a plurality of gas concentrations and temperatures during the calibration process. These constants are stored in the microprocessor memory and accessed during the calculation process by taking present gas signal measurements and concurrent temperature data which are then incorporated into the polynomial equation with the calibrated equation constants as obtained from the microprocessor memory with the result being the present level of gas concentration.

Determining Gas Concentration Using Phase Shift Change in NDIR Sensor Systems

According to certain embodiments, in an NDIR sensor system, the phase of the change in the NDIR output signal in response to a change in the infrared source emitter level is measured as part of the calibration process discussed above. The phase shift levels are recorded with other relevant parameters such as temperature, pressure, NDIR signal slope, or amplitude along with the current gas concentrations at a plurality of those relevant conditions. The results are stored in the memory system which is operably connected to the NDIR system microprocessor. The microprocessor uses received information for those parameters including the NDIR signals which may include NDIR signal phase information and compares that information with the calibration data stored in the connected memory to determine gas concentration. One example of an embodiment can be seen in the circuit of FIG. 4a/b/c, which, as discussed above, includes a comparator (internal to Microprocessor 2) that generates a signal when the NDIR output signal has risen sufficiently after the infrared emitter is enabled such that a voltage threshold is crossed and a signal is thereby generated. A timer internal coupled to or incorporated in the microprocessor 2 is initiated when the infrared emitter is enabled and is stopped when a voltage threshold is crossed. The time recorded between the start of operation of the IR emitter event and the crossing of the voltage threshold event is one example of a means to measure a NDIR signal phase shift. In one embodiment, this information may be incorporated along with the NDIR signal rise time and/or amplitude or other ambient inputs such as temperature upon which a calibration and gas concentration calculation is based. The means of calibration in one embodiment may incorporate a multi-variant approach as discussed above to create a calibration calculation using a method such as a least-squares fit in order to generate appropriate fitted variables, where the variables are stored in the microprocessor memory and used in determining gas concentration as discussed above.

Although the various embodiments of the present disclosure have been described with reference to preferred embodiments, persons skilled in the art will recognize that changes may be made in form and detail without departing from the spirit and scope of the present disclosure.

1. A NDIR sensor system for determining a gas concentration level, the system comprising:
a NDIR sensor for detecting an emitted infrared signal in response to the presence of a gas;
a circuit for receiving a signal from the NDIR sensor corresponding to the detected infrared signal, wherein the circuit generates a plurality of measurements based on the received signals such that the measurements correspond to a rate of voltage change in the received NDIR signal resultant from a change in an output level of an NDIR infrared emitter;
a memory for storing calibrated rate of voltage change data corresponding to a plurality of gas concentrations; and
a microprocessor coupled to the circuit and the memory for comparing the rate of voltage change from the received signals with the calibrated data and determining the gas concentration based on the comparison.

2. The system of claim 1, further comprising a NDIR signal amplifier comprising a track and hold configured differential amplifier, comprising:
a capacitor;
a switch for controlling a charge delivered to the capacitor, wherein the capacitor is charged with a baseline voltage, and upon opening the switch, the capacitor retains the baseline voltage; and
an amplifier, wherein the amplifier amplifies a difference between the baseline voltage and a sensed voltage corresponding to the infrared signal sensed by the NDIR sensor.

3. The system of claim 1, further comprising circuitry for measuring a pressure of the gas.

4. A NDIR sensor system for determining a gas concentration level, the system comprising:
a NDIR sensor for detecting an emitted infrared signal in response to the presence of a gas; and
a microprocessor for receiving data from the NDIR sensor associated with the sensed infrared signal and for receiving data associated with an ambient pressure;
wherein the microprocessor compensates for pressure effects on the NDIR sensor using the received ambient pressure data and calculates the gas concentration level based on the received data from the NDIR sensor associated with the sensed infrared signals.

5. The system of claim 4, further comprising a memory coupled to the microprocessor, wherein the memory stores calibrated gas concentration data, said calibrated gas concentration data based on a calibration curve generated by:
sampling gases at a plurality of gas concentrations occurring at a plurality of related ambient gas pressures;
measuring NDIR sensor signals of the sampled gas concentrations occurring at the plurality of the related ambient gas pressures;
determining a best fit calibration equation by approximating a calibration curve with a multi-variant fit based on the measured gas concentrations and the related ambient gas pressures; and
computing a set of fitted coefficients corresponding to the calibration curve based on the measured gas concentrations and the related ambient gas pressures; and
wherein the microprocessor receives data from the NDIR sensor associated with the sensed infrared signal and data from a pressure sensor comprising an associated measured ambient gas pressures, and calculates the gas concentration by applying the ambient gas pressure data and sensed infrared signal data as variables to the calibrated gas concentration data received from the memory.

6. The system of claim 5, wherein the calibrated gas concentration data is further based on temperature, such that the calibration curve is generated by:
sampling the gasses at the plurality of gas concentrations occurring at the plurality of ambient gas pressures and at a plurality of gas temperatures;
measuring the NDIR sensor signals of the sampled gas concentrations occurring at the plurality of ambient gas pressures and temperatures;
determining a best fit calibration equation by approximating a calibration curve with a multi-variant fit based on the measured gas concentrations, associated temperatures, and pressures; and
computing a set of fitted coefficients corresponding to the calibration curve based on the measured gas concentrations, related temperatures, and pressures; and
wherein the microprocessor further receives data associated with a measured gas temperature from a temperature sensor and calculates the gas concentration by applying the temperature data, gas pressure data, and the sensed infrared signal data as the variables to the calibrated gas concentration data received from the memory.

7. The system of claim 5, wherein the multi-variant fit is obtained at a plurality of pressures, such that a calibration curve is obtained for each measured pressure; and
wherein a weighted relationship of actual to calibrated pressure is used to interpolate the results between the calibrated curves at the plurality of pressures to produce a calibrated gas concentration result, the weighted actual to calibrated pressure relationship comprising an equation based on an amount of change in gas concentration as pressure changes between two consecutive pressure calibration curves.

8. A NDIR sensor system for determining a gas concentration level, the system comprising:
a NDIR sensor for detecting an emitted infrared signal in response to the presence of a gas;
a circuit for receiving and amplifying a signal from the NDIR sensor;
a memory for storing calibrated data corresponding to a plurality of gas concentrations;
a microprocessor coupled to the memory and the circuit for calculating the gas concentration based on the calibrated data and data received from the circuit; and
a means of limiting the system peak current demand which operates to supply a current required for an NDIR infrared emitter and to reduce a current required from an NDIR power supply source.

9. The system of claim 8, wherein the means of limiting the system peak current demand comprises an inrush current control circuit coupled to the NDIR power supply source.

10. The system of claim 9, wherein the means of limiting the system peak current demand further comprises a current buffer comprising a capacitor of at least 0.1 Farads coupled to the NDIR power supply source.

11. The system of claim 10, wherein the current buffer comprises a rechargeable battery.

12. The system of claim 8, wherein the means of limiting the system peak current demand comprises a current buffer comprising a capacitor of at least 0.1 Farads coupled to the NDIR power supply source.

13. The system of claim 12, wherein the current buffer comprises a rechargeable battery.

14. The system of claim 8, further comprising circuitry for measuring a pressure of the gas.

15. A NDIR sensor system for determining a gas concentration level, the system comprising:
a NDIR sensor for detecting an emitted infrared signal in response to the presence of a gas;
a memory for storing calibrated gas concentration data, wherein the stored calibrated gas concentration data is based on a calibration curve generated by:
sampling gases at a plurality of concentrations occurring at a plurality of ambient gas temperatures;
measuring NDIR sensor signals of the sampled gas concentrations occurring at the plurality of ambient gas temperatures;
determining a best fit calibration equation by approximating a calibration curve with a multi-variant fit based on the measured concentrations and associated temperatures; and
computing a set of fitted coefficients corresponding to the calibration curve based on the measured concentrations and related temperatures; and
a microprocessor for receiving data from the NDIR sensor associated with the sensed infrared signal and data from a temperature sensor associated with measured ambient gas temperatures and calculating the gas concentration by applying the received ambient gas temperature data and the received infrared signal data as variables to the calibrated gas concentration data received from the memory.

16. A NDIR sensor system for determining a gas concentration level, the system comprising:
a NDIR sensor for detecting an emitted infrared signal in response to the presence of a gas;
a circuit for receiving a signal from the NDIR sensor corresponding to the detected infrared signal, wherein the circuit generates measurements based on the received signals such that the measurements correspond to a phase shift in the received NDIR signal;
a memory for storing calibrated phase shift change data corresponding to a plurality of gas concentrations; and
a microprocessor for comparing the phase shift in the received NDIR signal with the calibrated phase shift change data and determining the gas concentration based on the comparison.
